(19) United States
(12) Patent Application Publication
(10) Pub. No.: US 2019/0295134 A1
(43) Pub. Date: Sep. 26, 2019

(54) METHOD FOR OPERATING A HOTEL IN ACCORDANCE WITH ENVIRONMENTAL CONSERVATION PRINCIPLES WHILE PROMOTING ENVIRONMENTAL AWARENESS AND VALUES

(71) Applicant: Wen Chang, Boulevard, CA (US)

(72) Inventor: Wen Chang, Boulevard, CA (US)

(21) Appl. No.: 15/933,794

(22) Filed: Mar. 23, 2018

(51) Int. Cl. G06Q 30/02; E04H 3/02; G06Q 10/02; G09B 7/06; G09B 7/02

(52) U.S. Cl. CPC G06Q 30/0279; E04H 3/02; G09B 7/02; G09B 7/06; G06Q 10/02

(57) ABSTRACT

A method for operating a hotel in accordance with environmental conservation principles, and for promoting environmental conservation values and ideas. The method includes a relatively inexpensive and single-level “Green” hotel certification program. The method emphasizes the emotional and consciousness aspects of managing an environmentally-friendly lodging facility. The method includes: assigning an environmentally-themed name to each hotel room in conjunction with a room number; providing a large screen TV in the hotel lobby configured to present a sequence of environmentally-themed images; encouraging environmentally-friendly guest behavior by rewarding such behavior with a valuable reward; installing a plurality of light tubes for illuminating rooms in the hotel with natural sunlight so as to reduce electricity consumption; playing continually in the lobby an environmentally-oriented audio message in an endless loop, thereby communicating a plurality of environmental messages; and placing an environmentally-themed book in each room.

### FIELD OF THE INVENTION

This invention relates generally to hotel operation and management, and particularly to operating a hotel so as to promote environmental values and awareness.

### BACKGROUND OF THE INVENTION

The United States Green Building Council (USGBC) is dedicated to “advancing better buildings”, and has certified at least 15 billion square feet of commercial real estate, including hundreds of hotels. The USGBC certified ninety-six prestigious hotel properties throughout the world, although the majority of the listed properties are in the US. However, due to its relatively high per-project fees—ranging from $30,000 to several hundred thousand dollars—its hospitality clients are, by necessity, weighted heavily to the higher end of the spectrum. Moreover, by offering multiple levels of certification, from bronze to platinum, this organization is able to justify even higher fees from its more ambitious clientele.

Green Globe is a U.S.-based firm which has its sights set on the whole world. Moreover, for maximal penetration, Green Globe's pricing is much more accessible, with registration fees starting at $650 per annum. Described as “a structured assessment of the sustainability performance of travel and tourism businesses, and their supply chain partners”, Green Globe appears to provide a fairly comprehensive process for “greening” the operations of a hotel. Nevertheless, Green Globe is focused primarily on the operational aspects of becoming eco-friendly, neglecting the more emotional and/or spiritual aspects of managing an environmentally friendly lodging facility.

Green Key, based in Canada, has made significant inroads into the U.S. market. Green Key describes itself as a “graduated rating system designed to recognize hotels, motels, and resorts that are committed to improving their environmental and fiscal performance.” Whereas the focus of USGBC is on the eco-friendliness of the buildings themselves, the focus of Green Key is on optimizing operations—specifically efficiencies in such areas as utility consumption, waste & emissions generation, and even overall operating costs. Presently, over 1,700 lodging facilities throughout the world are Green Key-certified.

Green Leaf, based in South Africa, has developed an Eco Standard (GLES) that is described as “a series of modules specifically constructed as sustainability and certification assessment tools for the performance management of any international . . . [hospitality] property.”

EarthCheck, based in Australia, is another international hospitality certification system. With a mission to “develop and deliver sustainable outcomes”, this organization provides comprehensive benchmarking, certification, design, and other services. In some respects, they are the Australian equivalent of the USGBC. However, their pricing seems to be somewhat less aggressive, with packages beginning in the range of roughly $3,000 to $5,000 AUS (approximately equivalent to $2,300 to $3,800 USD).

### SUMMARY OF THE INVENTION

The method of hotel operation of the invention creates an experience of total immersion in messages that promote environmental consciousness. Since today's environmental problems originate from the collective mindset, the method of hotel operation of the invention is configured to shift the mindset of hotel guests towards greater environmental understanding, awareness, and appreciation.

Environmentally friendly materials, products, and technologies are used together to synergistically generate maximum environmental message-delivering effect. Such materials, products, and technologies are used only to the extent that they optimize the experience and messages promoted by the hotel operation method of the invention.

The method of the invention includes a relatively inexpensive and single-level “Green” hotel certification program. The method emphasizes the emotional and consciousness aspects of managing an environmentally-friendly lodging facility, because today's environmental problems originate from the current collective mindset. Also, the emotional and consciousness aspects of green hospitality are what hotel guests remember most.

A general aspect of the invention is a method for operating a hotel in accordance with environmental conservation principles, and for promoting environmental conservation values. The method includes: requiring that an operator of the hotel pass a test about hotel operation according to the method; assigning an environmentally-themed name to each hotel room in conjunction with a room number; providing a large screen TV in the hotel lobby configured to present a sequence of environmentally-themed images; encouraging environmentally-friendly guest behavior by rewarding such behavior with a valuable reward; installing a plurality of light tubes for illuminating rooms in the hotel with natural sunlight so as to reduce electricity consumption; playing continually in the lobby an environmentally-oriented audio message in a continuous loop, thereby communicating a plurality of environmental messages; placing an environmentally-themed book in each room; making a charitable donation for each guest reservation to a charity of the guest's choice; equipping each room with an oxygenating shower head; and submitting to inspection annually so as to confirm substantial performance of the method.

In some embodiments, test includes true/false questions, multiple choice questions, and at least one essay.

In some embodiments, the sequence of images presented on the large screen TV in the hotel lobby is a sequence of environmentally-themed images illustrating each room name, presented in alphabetical order in accordance with the room names.

In some embodiments, the environmentally-friendly guest behavior is the guest generating electricity for use at the hotel using a stationary bicycle driving an electrical generator, and the valuable reward for the guest is airline miles and/or a meal in a restaurant at the hotel.

In some embodiments, installing a plurality of light tubes for illuminating rooms in the hotel with natural sunlight so as to reduce electricity consumption includes installing at least three light tubes in at least three respective rooms on an upper floor of the hotel.

In some embodiments, the environmentally-oriented audio message played in a continuous loop includes with the plurality of environmental messages, along with three noteworthy attractions near the hotel.

In some embodiments, placing an environmentally-themed book in each room includes placing an environmentally-themed pictorial book, along with an environmentally-themed book that is replaced with another environmentally-themed book every three months.

In some embodiments, the charitable donation for each guest reservation is $1, and the hotel will donate the $1 to a charity of the guest's choice.

In some embodiments, in addition to equipping each room with an oxygenating shower head, each room is also equipped with an air purifier, and a bed bug seal.

In some embodiments, the method further includes paying dues annually so as to be listed in a directory of compliant hotels according to the method.

Another general aspect of the invention is a method for operating a hotel in accordance with environmental conservation principles, and promoting environmental conservation values. This method includes: assigning an environmentally-themed name to each hotel room in conjunction with a room number; providing a large screen TV in the hotel lobby configured to present a sequence of environmentally-themed images; encouraging environmentally-friendly guest behavior by rewarding such behavior with a valuable reward; installing a plurality of light tubes for illuminating rooms in the hotel with natural sunlight so as to reduce electricity consumption; playing continually in the lobby an environmentally-oriented audio message in a continuous loop, thereby communicating a plurality of environmental messages; and placing an environmentally-themed book in each room.

In some embodiments, the sequence of images presented on the large screen TV in the hotel lobby is a sequence of environmentally-themed images illustrating each room name, presented in alphabetical order in accordance with the room names.

In some embodiments, the environmentally-friendly guest behavior is the guest generating electricity for use at the hotel using a stationary bicycle driving an electrical generator, and the valuable reward for the guest is airline miles and/or a meal in a restaurant at the hotel.

In some embodiments, installing a plurality of light tubes for illuminating rooms in the hotel with natural sunlight so as to reduce electricity consumption includes installing at least three light tubes in at least three respective rooms on an upper floor of the hotel.

In some embodiments, the environmentally-oriented audio message played in a continuous loop includes along with the plurality of environmental messages, messages regarding three noteworthy attractions in the area near the hotel.

In some embodiments, placing an environmentally-themed book in each room includes placing an environmentally-themed pictorial book, along with an environmentally-themed book that is replaced with another environmentally-themed book every three months.

In some embodiments, in addition to equipping each room with an oxygenating shower head, each room is also equipped with an air purifier, and a bed bug seal.

In some embodiments, the method further includes paying dues annually so as to be listed in a directory of compliant hotels according to the method.

In some embodiments, the method further includes: requiring that an operator of the hotel pass a test about hotel operation according to the method, the test including true/false questions, multiple choice questions, and at least one essay; and submitting to inspection annually so as to confirm substantial performance of the method.

In some embodiments, the method further includes making a charitable donation for each guest reservation to a charity of the guest's choice, the charitable donation for each guest reservation being $1, the hotel donating the $1 to a charity of the guest's choice.

### BRIEF DESCRIPTION OF THE DRAWINGS

Many additional features and advantages will become apparent to those skilled in the art upon reading the following description, when considered in conjunction with the accompanying drawings, wherein:

FIG. 1 is a block diagram showing some steps of the method; and

FIG. 2 is a block diagram showing some more steps of the method.

### DETAILED DESCRIPTION

The present invention provides a method for certifying hotels as environmentally friendly (or “green”) in a manner that is affordable to independently-owned mid-tier hotels, and that enhances the appeal of their establishments to environmentally conscious patrons. Also, the method of the invention inspires and instructs hotel owners on how to implement more ecological practices in their business operations, while inspiring owners and patrons alike to adopt a more environmentally conscious outlook on a personal level.

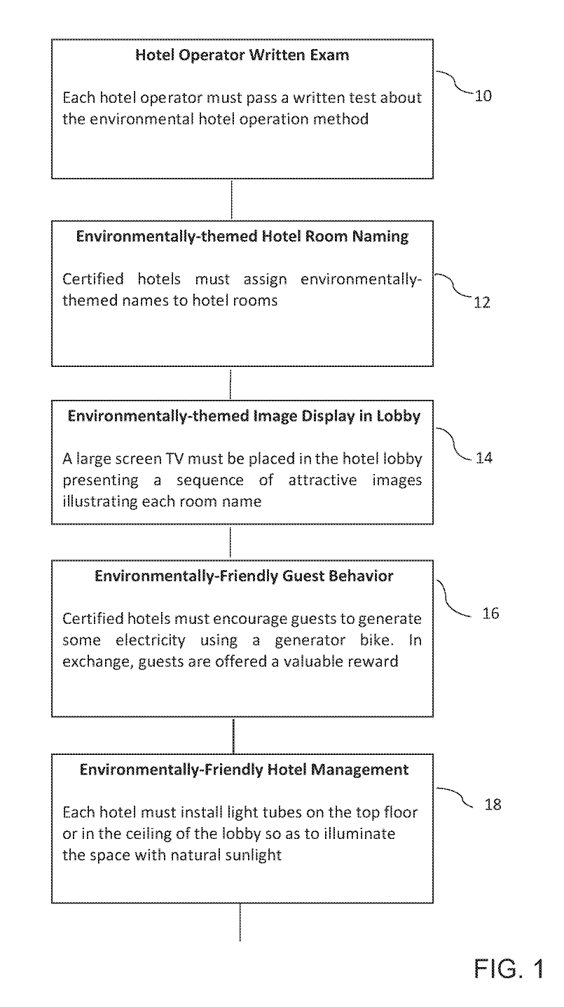

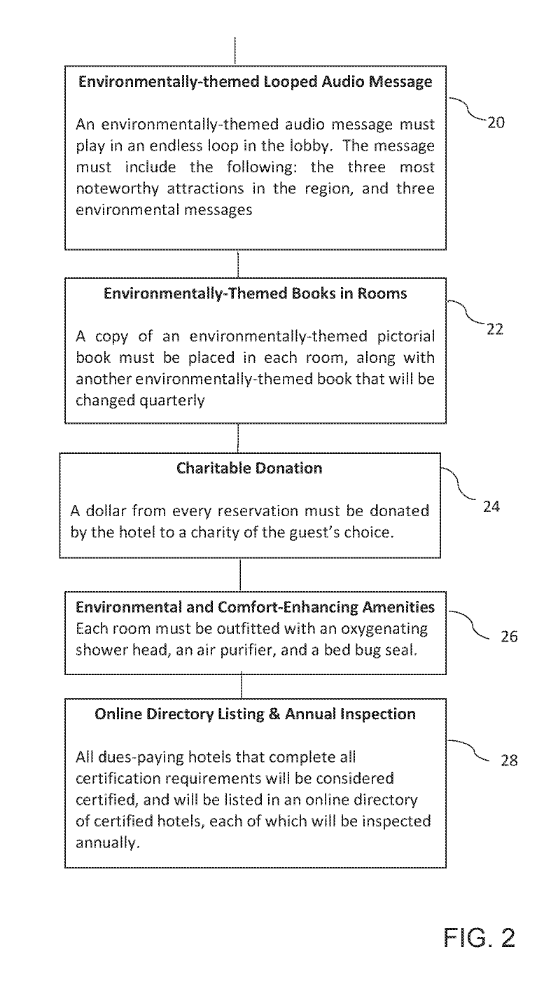

Referring to FIGS. 1 and 2, a sequence of actions are presented, but the order of presentation of these actions is just one of many orders that the actions can be performed.

With reference to step 10, a written examination for hotel operators is required for a hotel operator to attain and maintain this certification. This examination covers the technical aspects of the recommended program for environmentally-friendly hotel operations, as well as the philosophical principles that inform the program. In terms of structure, the examination can consist of twenty-five true-false questions, twenty-five multiple choice questions, and one essay about environmentalism. Any applicant that does not attain a passing grade will be afforded another opportunity to sit for the examination. Moreover, the applicant will be coached by a representative of the certification program to help ensure a passing performance during the next sitting.

### A Sample Essay Question:

Please explain the origin of the term GAIA, and it's scientific meaning.

### Model Answer:

1) Gaia is the ancient concept from Greek Mythology of Mother Earth. Gaia is the Mother of all beings that protects all species on Earth. Gaia is Alive.
2) The Chemist James Lovelock and the Biologist Lynn Margulis co-created the Gaia Hypothesis, asserting that Mother Earth has a self-regulatory mechanism that maintains the optimal living conditions for all species on Earth. For example, if the concentration of oxygen in the atmosphere rises 2%, all forest will catch fire and be destroyed. Alternatively if the concentration of oxygen in the atmosphere falls 2%, then all life on Earth will die.
3) Changing one's perspective from the Earth being inorganic and dead, to the Earth being an organic living entity that we are part of, represents a great shift of mindset. Instead of saying: “I'm protecting the forest”, we can shift our perspective by identifying ourselves with the forest. So instead we feel: “I'm protecting myself, since the forest and I are one”. Thus, the Gaia concept helps us to shift from duality and disharmony to oneness and a harmonious wholeness.

### A Sample Multiple Choice Question:

Please select from the four choices below the statement that is true regarding today's environmental movement:
A) All green technologies and products used individually contribute to the wellbeing of the whole.
B) Aesthetic and natural beauty enriches one's true self.
C) Green Messages and Experiences will last thru time longer than good service provided by a hotel.
D) All of the above
Correct answer: D

### A Sample True/False Question:

All certified green hotels owners are true green participators, while others are not.
Correct answer: False
Because today's environmental movement is Humankind's collective consciousness awakening. Everyone has the same level of awakening, just as each bird in a flock of birds, or each fish in a school of fish all know when to make a turn simultaneously without the direction of a leader. An important aspect of the method of the invention is to bring more people into an awakening of environmental consciousness.

With reference to step 12, the method of the invention requires that an environmentally-themed room naming program be implemented. This is an important step in the physical conversion of an ordinary independent hotel into one that is compliant with the hotel operation method of the invention. The rooms in a compliant hotel according to the invention are to be named after an endangered species of flora or fauna, such as “snow leopard”, or something else that symbolizes the fragility of planet earth. For example, “Bora Bora”, a beautiful island environment that is currently threatened by rising sea levels, is also a recommended name. Moreover, as a symbol of recycling, the wooden door plates on which those names are printed are made from hurricane-destroyed Southeast Asian banyan trees, for example. In some embodiments, the interior of rooms named in this manner can be decorated with photographs, drawings, and other media portraying the animal, plant, or other endangered entity named on the door.

With reference to step 14, the method of the invention requires the display of environmentally-conscious video content on a large (e.g., 50 inches or greater) television or video monitor. What should be displayed is visually attractive video content related to all of the endangered species and other endangered or fragile natural entities referred to and used as room names. Such content should include a potent mix of eye-catching images interlaced with compelling and inspiring and educational text messages about the environment, environmentally conscious living, and our connection to and responsibility for the natural world. The content can advantageously be presented in alphabetical order (e.g., the content pertaining to Bora Bora will precede the content about snow leopards). In this manner, even someone who comes into the hotel lobby for just a few minutes will be exposed to some environmentally consciousness-raising content.

Referring to step 16, the method requires that the hotel incentivize environmentally-friendly guest behavior, such as encouraging and enabling guests to exerting moderate effort on a stationary bicycle equipped with an electrical generator so as to generate and store electrical power that the hotel can use. In this manner, guests learn not to take the availability of electrical power for granted, and thereby become more conscious about conserving electrical power in their lives back at home. Guests are incentivized to partake in this consciousness-raising experience with an offer of airline miles, a complementary meal in the hotel restaurant, or other valuable or tangible reward. The combination of exercise and energy-saving is intended to be both instructive and inspirational for hotel guests. Such an experience enhances the stay of guests, and imbues them with more meaning and value than a stay at a hotel not certified in accordance with the method of the invention.

Referring to step 18, environmentally-friendly hotel management is encouraged by the method of the invention, such as by requiring that the hotel operator install at least three light tubes, such as Solatubes®, on an upper floor of the hotel and/or in the lobby of the hotel. In this manner, all of those rooms are illuminated with natural sunlight from six in the morning until six in the evening, thereby reducing the use of electric light bulbs in those rooms significantly. Consequently, especially if implemented throughout an upper floor, the regular use of light tubes, such as Solatubes®, can reduce the hotel's electricity bill by a noticeable amount. Aside from reducing the consumption of electricity in the hotel, the use of light tubes, such as Solatubes®, is also intended as a consciousness-raising experience for both guests and hotel owners and a reminder that, through innovation, going green can actually be economically advantageous.

With reference to step 20, environmentally-themed audio content must be played as a repeating loop in the lobby on an ongoing basis. The message, ideally to be recorded by the hotel's front office manager or general manager, should introduce three local attractions worth visiting. Interspersed with information about local points of interest are three environmental messages pertaining to three eco-friendly items or initiatives in the hotel, what they represent, and how they transform our daily lives. A script for these environmental messages can be obtained from the hotel certification representative, but it is up to each hotel operator to write the content about local attractions.

Regarding step 22, the method of the invention requires that at least one environmentally-themed book be placed in each room to be enjoyed by guests. For example, the book Sweet Dreams, by Wen Chang, an environmentally-themed pictorial book, could be placed in each room of the hotel. Aside from environmentally-themed children's art, this book also includes a statement about the environment, an environmentally-themed poem, one hundred ecologically-friendly tips, and helpful bedtime suggestions for falling asleep. As well, alongside Wen Chang's book, a larger environmentally-themed pictorial “coffee table” book should be placed. This larger book should be changed on a monthly or quarterly basis, as part of a rotating series of visually attractive consciousness-raising books. The presence of such books in each room will ensure that those guests who are eager to expand their environmental awareness further on their own initiative will be enabled to do so.

With reference to step 24, the method of hotel operation of the invention includes a requirement that the hotel facilitate charitable donations. For example, one dollar from every reservation is donated by the hotel to a charity of the guest's choosing. Through a payment processing system that the certification program will provide, this step will be automated in such a way that these guest donations will be simple and quick for hotel operator and guest alike. Step 24 is intended to raise the environmental consciousness of each guest, and enhance the sense of wider responsibility and interconnectedness that lies at the root of all conservationist ideas and practices. This act of charity will help hotel operators and guests progress from self-actualization to self-transcendence, the highest level of psychologist Abraham Maslow's hierarchy of needs, and an important element of the philosophy that led to the creation of the method of the invention.

With reference to step 26, ecologically-friendly amenities must be provided by hotel operator in each room. For example, each guest bathroom must have a shower with an oxygenating shower head, such as an Oxygenics® shower head, so as to help preserve healthy skin. Moreover, such showerheads typically are very efficient regarding use of water and use of energy.

Each hotel room must also have an air purifier near the bed area to ensure enhanced breathing of pure air. Also, each hotel bed must include a bed bug seal for enhanced cleanliness. All of these amenities can have a significant and tangible impact on the quality of a guest's stay. Consequently, these amenities help dispel the notion that a green hotel experience might be less comfortable than a regular one. Instead, the method of the invention ensures that guests understand that environmental awareness and empathy enhances one's experience, which is hoped to lead to a shift in their personal philosophy regarding the environment and related matters.

With reference to step 28, an annual inspection of all certified hotels will be performed so as to ensure ongoing program compliance and satisfactory application of the method of the invention. Step 28 also pertains to an annually-updated online directory system. Those hotel owners that pass inspection will retain certification and all of its attendant branding and promotional advantages. Promotional advantages include being listed in an online directory and booking system provided by the certification program. The booking system will only include hotels that have been certified in accordance with the method of the invention, and will be promoted aggressively by the certification membership program at no additional charge to member hotels. Also on an annual basis, all dues-paying hotels that complete all of these listed processes will be awarded a brand new membership plaque, the membership plaque being made from recycled glass, thereby serving as a symbol of the values of the hotel certification system of the invention.

Other modifications and implementations will occur to those skilled in the art without departing from the spirit and the scope of the invention as claimed. Accordingly, the above description is not intended to limit the invention, except as indicated in the following claims.

What is claimed is:

1. A method for operating a hotel in accordance with environmental conservation principles, the method comprising:
requiring that an operator of the hotel pass a test about hotel operation according to the method;
assigning an environmentally-themed name to each hotel room in conjunction with a room number;
providing a large screen TV in the hotel lobby configured to present a sequence of environmentally-themed images;
encouraging environmentally-friendly guest behavior by rewarding such behavior with a valuable reward;
installing a plurality of light tubes for illuminating rooms in the hotel with natural sunlight so as to reduce electricity consumption;
playing continually in the lobby an environmentally-oriented audio message in a continuous loop, thereby communicating a plurality of environmental messages;
placing an environmentally-themed book in each room;
making a charitable donation for each guest reservation to a charity of the guest's choice;
equipping each room with an oxygenating shower head; and
submitting to inspection annually so as to confirm substantial performance of the method.

2. The method of claim 1, wherein the test includes true/false questions, multiple choice questions, and at least one essay.

3. The method of claim 1, wherein the sequence of images presented on the large screen TV in the hotel lobby is a sequence of environmentally-themed images illustrating each room name, presented in alphabetical order in accordance with the room names.

4. The method of claim 1, wherein the environmentally-friendly guest behavior is the guest generating electricity for use at the hotel using a stationary bicycle driving an electrical generator, and the valuable reward for the guest is airline miles and/or a meal in a restaurant at the hotel.

5. The method of claim 1, wherein installing a plurality of light tubes for illuminating rooms in the hotel with natural sunlight so as to reduce electricity consumption includes installing at least three light tubes in at least three respective rooms on an upper floor of the hotel.

6. The method of claim 1, wherein the environmentally-oriented audio message played in a continuous loop includes with the plurality of environmental messages, along with three noteworthy attractions near the hotel.

7. The method of claim 1, wherein placing an environmentally-themed book in each room includes placing an environmentally-themed pictorial book, along with an environmentally-themed book that is replaced with another environmentally-themed book every three months.

8. The method of claim 1, wherein the charitable donation for each guest reservation is $1, and the hotel will donate the $1 to a charity of the guest's choice.

9. The method of claim 1, wherein in addition to equipping each room with an oxygenating shower head, each room is also equipped with an air purifier, and a bed bug seal.

10. The method of claim 1, further including:
paying dues annually so as to be listed in a directory of compliant hotels according to the method.

11. A method for operating a hotel in accordance with environmental conservation principles, the method comprising:
assigning an environmentally-themed name to each hotel room in conjunction with a room number;
providing a large screen TV in the hotel lobby configured to present a sequence of environmentally-themed images;
encouraging environmentally-friendly guest behavior by rewarding such behavior with a valuable reward;
installing a plurality of light tubes for illuminating rooms in the hotel with natural sunlight so as to reduce electricity consumption;
playing continually in the lobby an environmentally-oriented audio message in a continuous loop, thereby communicating a plurality of environmental messages; and
placing an environmentally-themed book in each room.

12. The method of claim 11, wherein the sequence of images presented on the large screen TV in the hotel lobby is a sequence of environmentally-themed images illustrating each room name, presented in alphabetical order in accordance with the room names.

13. The method of claim 11, wherein the environmentally-friendly guest behavior is the guest generating electricity for use at the hotel using a stationary bicycle driving an electrical generator, and the valuable reward for the guest is airline miles and/or a meal in a restaurant at the hotel.

14. The method of claim 11, wherein installing a plurality of light tubes for illuminating rooms in the hotel with natural sunlight so as to reduce electricity consumption includes installing at least three light tubes in at least three respective rooms on an upper floor of the hotel.

15. The method of claim 11, wherein the environmentally-oriented audio message played in a continuous loop includes along with the plurality of environmental messages, messages regarding three noteworthy attractions in the area near the hotel.

16. The method of claim 11, wherein placing an environmentally-themed book in each room includes placing an environmentally-themed pictorial book, along with an environmentally-themed book that is replaced with another environmentally-themed book every three months.

17. The method of claim 1, wherein in addition to equipping each room with an oxygenating shower head, each room is also equipped with an air purifier, and a bed bug seal.

18. The method of claim 1, further including:
paying dues annually so as to be listed in a directory of compliant hotels according to the method.

19. The method of claim 11, further including:
requiring that an operator of the hotel pass a test about hotel operation according to the method, the test including true/false questions, multiple choice questions, and at least one essay; and
submitting to inspection annually so as to confirm substantial performance of the method.

20. The method of claim 11, further including:
making a charitable donation for each guest reservation to a charity of the guest's choice, the charitable donation for each guest reservation being $1, the hotel donating the $1 to a charity of the guest's choice.
